(19) United States
(12) Patent Application Publication
(10) Pub. No.: US 2011/0141129 A1
(43) Pub. Date: Jun. 16, 2011

(54) IMAGE INFORMATION PROCESSING APPARATUS, IMAGE INFORMATION PROCESSING METHOD AND COMPUTER READABLE MEDIUM

(75) Inventor: Yasushi NISHIDE, Kanagawa (JP)

(73) Assignee: FUJI XEROX CO., LTD., Tokyo (JP)

(21) Appl. No.: 12/787,739

(22) Filed: May 26, 2010

(30) Foreign Application Priority Data
Dec. 14, 2009 (JP) 2009-282979

(51) Int. Cl. G09G 5/02

(52) U.S. Cl. 345/589

(57) ABSTRACT

According to an aspect of the invention, an image information processing apparatus includes an input unit, a search unit, and an invalidation unit. The input unit is a unit to which image forming information containing a drawing command for an apparatus for forming an image on a medium is input. The search unit searches the image forming information for a given drawing command of a white image element, the given drawing command containing an over command to set a color of a portion overlapping a different image element in a color determined by a relationship with the color of the different image element. The invalidation unit invalidates the over command in the given drawing command found by the search unit.

### CROSS-REFERENCE TO RELATED APPLICATIONS

This application is based upon and claims priority under 35 USC 119 from Japanese Patent Application No. 2009-282979, filed Dec. 14, 2009.

### BACKGROUND

Technical Field

This invention relates to an image information processing apparatus, an image information processing method and computer readable medium.

### SUMMARY OF THE INVENTION

According to an aspect of the invention, an image information processing apparatus includes an input unit, a search unit, and an invalidation unit. The input unit is a unit to which image forming information containing a drawing command for an apparatus for forming an image on a medium is input. The search unit searches the image forming information for a given drawing command of a white image element, the given drawing command containing an over command to set a color of a portion overlapping a different image element in a color determined by a relationship with the color of the different image element. The invalidation unit invalidates the over command in the given drawing command found by the search unit.

### BRIEF DESCRIPTION OF THE DRAWINGS

Exemplary embodiments of the invention will be described in detail based on the following figures, wherein:

FIG. 1 is a block diagram to represent a configuration example and a connection example of an image information processing apparatus according to an exemplary embodiment of the invention;

FIGS. 2A to 2D show examples of image elements where overprint is set;

FIG. 3 is a flowchart to represent an example of processing of the image information processing apparatus according to the exemplary embodiment of the invention;

FIG. 4 is a schematic representation to represent an example of a set screen in the image information processing apparatus according to the exemplary embodiment of the invention; and

FIG. 5 is a flowchart to represent another example of processing of the image information processing apparatus according to the exemplary embodiment of the invention.

### DETAILED DESCRIPTION

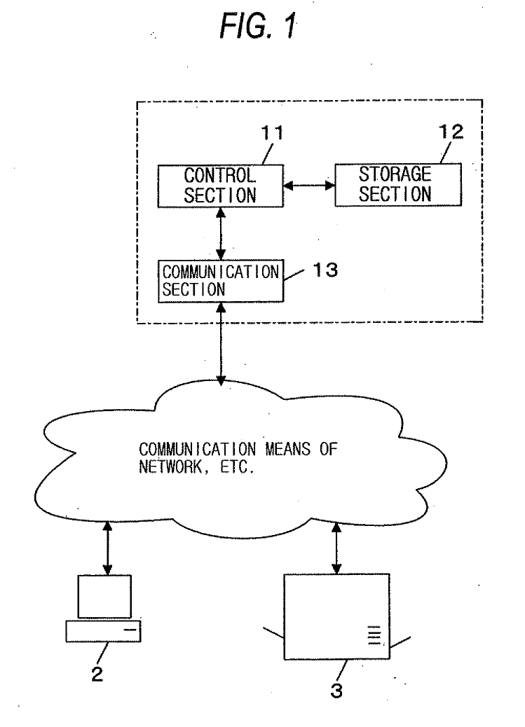

An exemplary embodiment of the invention will be discussed with reference to the accompanying drawings. An image information processing apparatus 1 according to the exemplary embodiment intervenes between an information processing apparatus 2 and an image forming apparatus 3 as illustrated in FIG. 1. The image information processing apparatus 1 according to the exemplary embodiment is made up of a control section 11, a storage section 12, and a communication section 13. The image information processing apparatus 1 according to the exemplary embodiment is not limited to that as illustrated here; it may be made integral with the image forming apparatus 3 or may be made integral with the information processing apparatus 2.

The control section 11 is a program control device of a CPU (Central Processing Unit), etc., and operates in accordance with a program stored in the storage section 12. In the example of the exemplary embodiment, the control section 11 accepts image forming information from the information processing apparatus 2 through the communication section 13 and searches the image forming information for a drawing command of a white object which setting is set to overprint specification (over command). The overprint specification means a setting to draw a color of a portion overlapping a different image element in a color determined by the relationship with the color of the different image element. If the drawing command of the white object exists, the control section 11 executes processing to invalidate the overprint specification. The color in the drawing command is represented by the color material use amount for each of a plurality of colorplates containing cyan, magenta, yellow, and black. White mentioned here means a color with the value of each colorplate being 0%. Specific description of the processing is given later.

The storage section 12 is a memory device, etc., and holds a program executed by the control section 11. The program may be stored in a computer-readable record medium such as a DVD-ROM (Digital Versatile Disc Read-Only Memory), for example, and may be provided and stored in the storage section 12. The storage section 12 also operates as work memory of the control section 11. The communication section 13 is a network interface, etc., and transmits and receives various pieces of information to and from the information processing apparatus 2 and the image forming apparatus 3 in accordance with a command input from the control section 11.

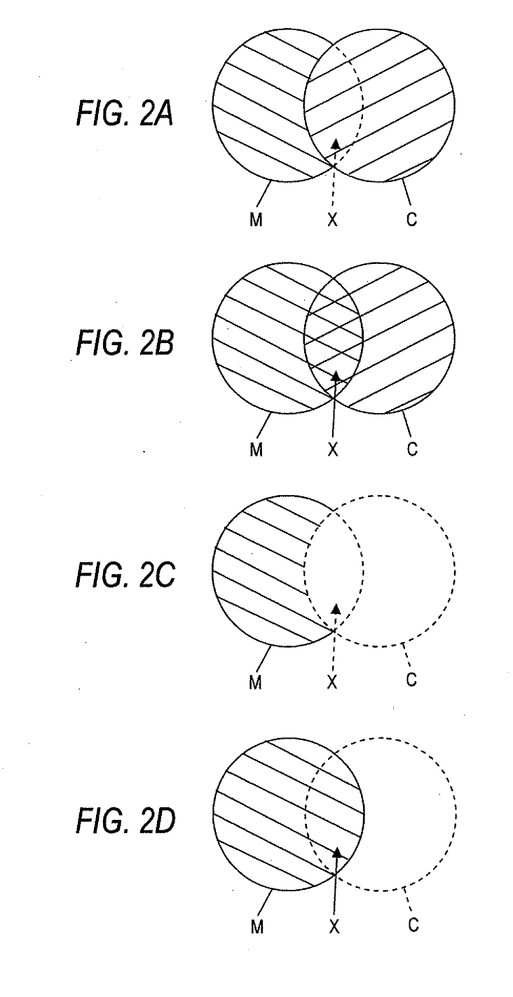

The information processing apparatus 2 is a general personal computer system. The information processing apparatus draws at least one image element in accordance with a command of the user to display the image element on a display and also generates image forming information containing a drawing command of the image element. The information processing apparatus 2 also outputs the generated image forming information to the image information processing apparatus according to a command from the user. The user can specifically operate the information processing apparatus 2 to draw an image element as illustrated in FIGS. 2A to 2D. First, when a disk image element (M) colored in magenta 100% is drawn and a disk image element (C) colored in cyan 100% is drawn so as to overlap a part of that disk, the inside of the disk image element (C) containing the cross portion (X) is colored in cyan 100% on the display image and the cross portion of the disk image element (M) is hidden (FIG. 2A; for the description, the hidden portion of each image element is also represented by a dashed line; in fact, however, the dashed line is not displayed).

Next, if the user makes setting so as to overprint the disk image element (C) for the information processing apparatus 2, although no change occurs on the display, overprint specification is added to image forming information. If an image is formed in accordance with the image forming information, the cross portion (X) of both the disk image elements (M and C) is formed in a color of magenta 100% and cyan 100% (FIG. 2B).

On the other hand, in the state shown in FIG. 2A, if the user operates the information processing apparatus 2 to set the color of the disk image element (C) to white (color with all plates 0%), the inside of the disk image element (C) containing the cross portion (X) is colored in while on the display and the cross portion of the disk image element (M) is hidden (FIG. 2C). However, in the image forming information, overprint specification for the disk image element (C) remains. Thus, if an image is formed in accordance with the image forming information, the cross portion (X) of both the disk image elements (M and C) is formed in a color of magenta 100% (FIG. 2D). This means that output not intended by the user is obtained.

The image forming apparatus 3 is a color printer, a multiple function apparatus including the functions of a color printer, scanner, a copier, etc., and forms an image on a medium of a sheet of paper, etc., in accordance with the image forming information output by the information processing apparatus 2.

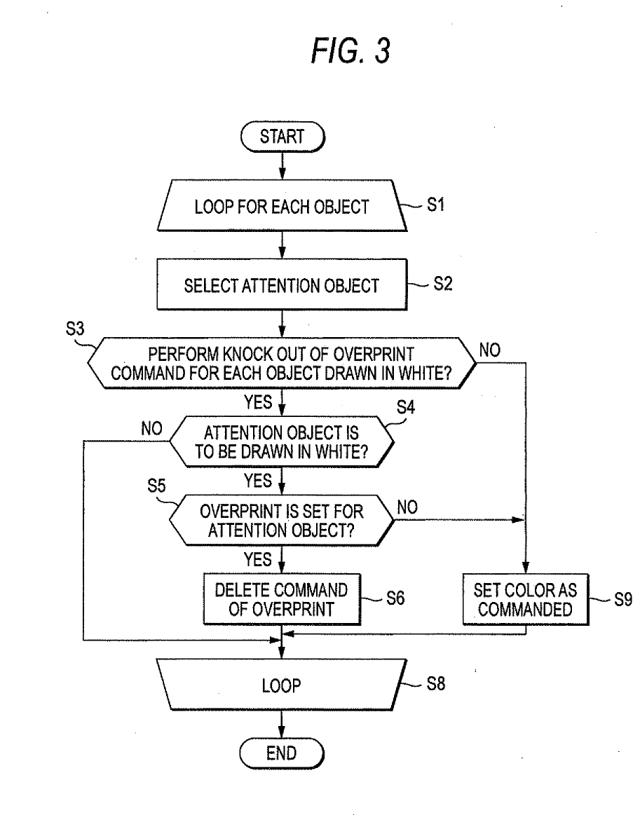

Next, the operation of the control section 11 of the image information processing apparatus 1 will be discussed. Upon reception of image forming information from the information processing apparatus 2, the control section 11 performs processing of setting color of each image element of an image to be formed in accordance with the command. An example of the processing is as illustrated in FIG. 3.

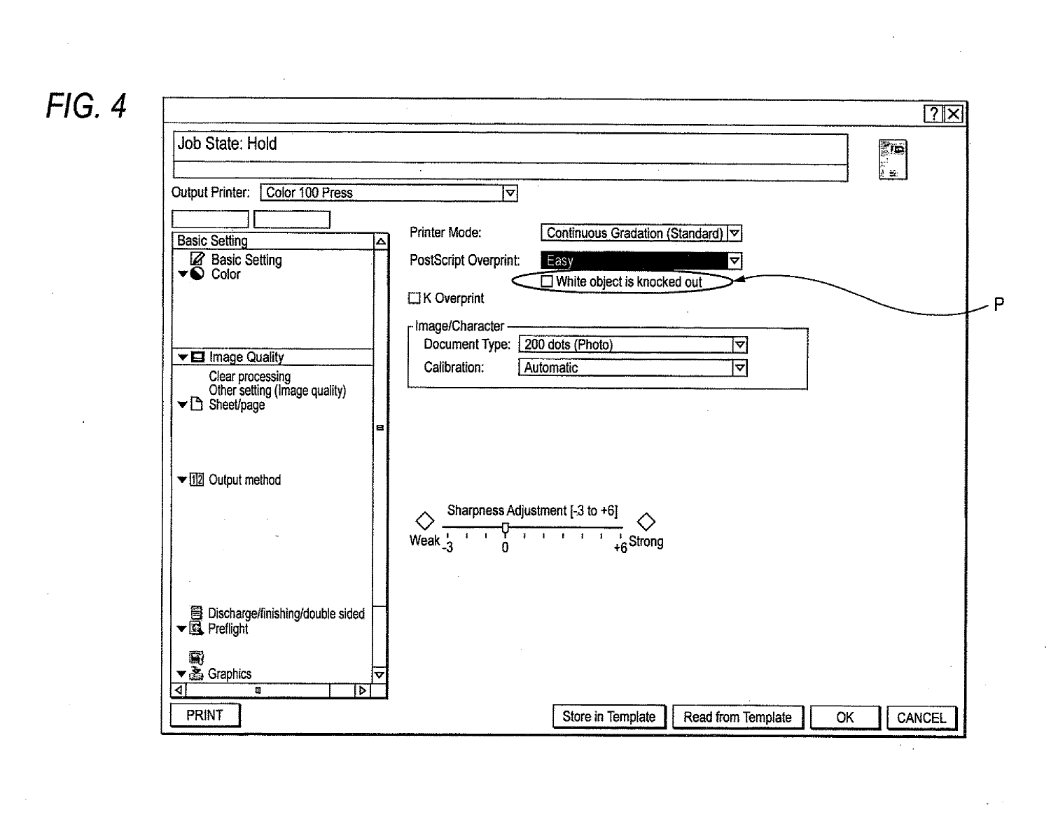

Before the processing illustrated in FIG. 3, the control section 11 accepts setting as to whether or not to perform knock out (setting release) of an overprint command for each object drawn in white (color with all plates 0%) according to a set screen as illustrated in FIG. 4 and records the setting in the storage section 12.

When starting the processing illustrated in FIG. 3, the control section 11 selects one of drawing objects (objects) of image elements, etc., contained in received image forming information (S1) as an attention object (S2). The control section 11 references the setting recorded in the storage section 12 and determines whether or not to perform knock out (setting release) of the overprint command for each object drawn in white (color with all plates 0%) (S3).

In the selection of object (S2), the attention object is selected in order of layer from bottom side to up side when some objects are layered. The above selection order is common knowledge in the art of this embodiment.

If knock out setting is made (YES), whether or not the drawing color specified for the attention object is white (color with all plates 0%) is determined (S4). If the drawing color specified for the attention object is white (Yes), whether overprint command is set for the attention object or not is determined (S5). If overprint command is set for the attention object (YES), the overprint command is deleted from the received image forming information (SE) and the command is changed to setting of the color of the attention object to white (color with all plates 0%).

While an object not yet selected as the attention object is contained in the received image forming information, the control section 11 repeats step S2 and the later steps (S8) and if color is set for all objects, the processing is terminated.

If setting of knock out is not made (NO) at step S3 or if no overprint command is set for the attention object (NO) at step S5, the control section 11 sets the color of the attention object as the command set for the attention object, reflects the setting on the image forming information (S9), and goes to step S8. If the knock out is not set at step S3 (NO), even an object for which a white drawing command and an overprint command are set is set to the color as commanded and thus if an object of a different color overlaps as the background of the attention object, the overlap portion is drawn in the different color.

If no overprint command is set for the attention object (NO) at step S5, the drawing color specified for the attention object (in the processing example in FIG. 3, white) is adopted as the drawing color of the attention object as it is. That is, the object of the background of the attention object is overwritten by the attention object and the overlap portion with the attention object is lost for drawing.

Further, if the drawing color specified for the attention object is not white (color with all plates 0%) (NO) at step S4, the control section 11 goes to step S8. After completing the processing shown in FIG. 3, the control section 11 outputs the image forming information after the processing to the image forming apparatus 3.

In the exemplary embodiment, such processing is performed, whereby the following operation is performed: In the description of the following operation example, it is assumed that image forming information is described in PostScript (registered trademark). The exemplary embodiment is not limited to the example based on PostScript and similar processing can be performed for any other page description language. The case where drawing operation as shown in FIGS. 2A to 2D is performed is assumed by way of example. First, a disk image element colored in magenta 100% is drawn and a disk image element colored in cyan 100% is drawn so as to overlap that disk (as in FIG. 2A on the display). At this time, drawing commands of image forming information generated by the information processing apparatus 2 become typically

draw_magenta_oval
draw_cyan_oval
Here, it is assumed that draw_magenta_oval is a drawing command (command) to draw a disk image element colored in magenta 100% and draw_cyan_oval is a drawing command to draw a disk image element colored in cyan 100%.

Next, if the user makes setting to overprint the disk image element (C) for the information processing apparatus 2, although no change occurs on the display, overprint specification is added to image forming information and the commands become like

draw_magenta_oval
true overprintmode
draw_cyan_oval
false overprintmode
Here, “true overprintmode” becomes a command to overprint and drawing the following image element. “false overprintmode” becomes specification to release overprint.

If an image is formed in accordance with the image forming information, the cross portion (X) of both the disk image elements (M and C) is formed in a color of magenta 100% and cyan 100% (FIG. 2B).

If the user operates the information processing apparatus 2 to set the color of the disk image element in cyan 100% to white (color with all plates 0%), the inside of the disk image element containing the cross portion is colored in white on the display and the cross portion of the disk image element in magenta 100% is hidden (FIG. 2C).

At this time, the image forming information generated by the information processing apparatus 2 becomes

draw_magenta_oval
true overprintmode
draw_white_oval
false overprintmode

Here, draw_white_oval is a drawing command (command) to draw a disk image element with cyan, magenta, yellow, and black colorplates 0%.

In this state, the overprint command for the disk image element specified in white remains. Thus, if an image is formed in accordance with the image forming information, the cross portion of both the disk image elements is formed in the color of magenta 100% (FIG. 2D). This means that output not intended by the user is obtained.

The image forming information in this state is transmitted from the information processing apparatus 2 to the image information processing apparatus 1. In the following example, it is assumed that a command to perform knock out (setting release) of an overprint command for an object drawn in white (color with all plates 0%) is preset for the image information processing apparatus 1.

The image information processing apparatus 1 selects one of objects as an attention object. In the example described above, first, draw_magenta_oval is selected as the attention object. Whether or not the drawing color specified for the attention object is white (color with all plates 0%) is determined. Since magenta 100% is set for the attention object, a transition is made to processing for the next object.

Next, the image element drawn according to the command from true overprintmode to draw_white_oval becomes an attention object. Since the drawing color of the attention object is white, then whether or not an overprint command for the attention object is set is determined. Here, since true overprintmode is set, it is determined that overprint command is set, and the overprint command is deleted from the received image forming information.

The processing is performed, whereby the previous image forming information becomes

draw_magenta_oval
false overprintmode
draw_white_oval
false overprintmode
In this example, a change is made to the command to set the color of the attention object to white (color with all plates 0%).

The image information processing apparatus 1 performs similar processing for objects contained in the image forming information and if colors are set for all objects, the processing is terminated.

When the image forming apparatus 3 forms an image based on the generated image forming information, the result matching representation on the display shown in FIG. 2C is obtained and the result as intended by the user is obtained.

### [Another Example of Processing]

In recent years, to deal with drawing not intended as there is an overprint command for a white object, the image information processing apparatus I may contain a processing command of replacing a drawing command of an image element in white involving overprint specification with a command to draw nothing in image forming information.

In so doing, at the stage previewing in the image information processing apparatus 1, the image element to be drawn in white is not drawn and the user can be aware of the anomaly. However, the result of such processing is also the same as the state not intended by the user. Then, the image information processing apparatus 1 of the exemplary embodiment may perform the following processing:

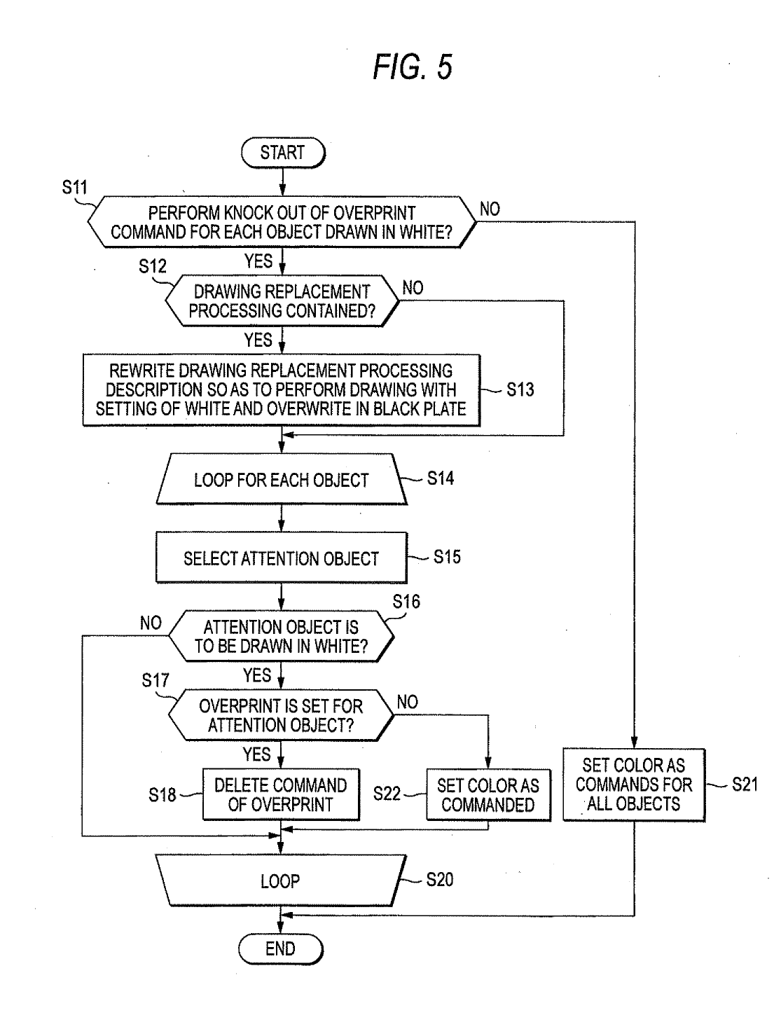

Upon reception of image forming information from the information processing apparatus 2, the control section 11 of the image information processing apparatus 1 of the exemplary embodiment executes processing shown in FIG. 5 in place of the processing shown in FIG. 3. That is, the control section 11 references the setting recorded in the storage section 12 and determines whether or not an overprint command for an object drawn in white (color with all plates 0%) is knocked out (setting is released) (S11).

If setting to knock out is made (YES), the control section checks whether or not the received image forming information contains description of processing of replacing a drawing command of an image element in white involving overprint specification with a command to draw nothing (called drawing replacement processing) (S12).

The drawing replacement processing becomes as follows specifically in an example of PostScript (registered trademark) (the exemplary embodiment is not limited to the PostScript example): If overprint is set, in some information processing apparatus 2, processing is processing of rewriting so that colors represented in colorplates (DeviceCMYK) of process colors of cyan, magenta, yellow, and black are represented in DeviceN (information to set the concentration of an arbitrary color plate). At this time, color of cyan, magenta, yellow, and black 0% in DeviceCMYK is set as color of DeviceNone (unoutput plate) rather than DeviceN.

The image forming information containing the description of the drawing replacement processing is processed in the image forming apparatus 3, the drawing replacement processing is executed in the image forming apparatus 3, an image element (object) with setting of white and overprint is drawing in DeviceNone color, and the result of the drawing is not output.

If the drawing replacement processing is contained (YES) at step S12, the control section 11 replaces the description of processing of rewriting an image element with setting of drawing in color of cyan, magenta, yellow, and black 0% in DeviceCMYK and overprint to a command to draw in color of DeviceNone (unoutput plate) with description of processing of rewriting to a command to draw in color of DeviceK (black colorplate) 0%, for example, so as to become a command to overwrite in white.

In the above example, DeviceC (cyan colorplate) 0%, DeviceM (magenta colorplate) 0%, or DeviceY (yellow colorplate) 0% may be used instead of DeviceK.

The control section 11 selects one of drawing objects (objects) of image elements, etc., contained in received image forming information (S14) as an attention object (S15).

The control section 11 determines whether or not the drawing color specified for the attention object is white (color with all plates 0%) (S16). If the drawing color specified for the attention object is white (Yes), whether or not overprint command is set for the attention object is determined (S17). If overprint command is set for the attention object (YES), the control section 11 deletes the overprint command from the received image forming information (S6) and changes the command to setting of the color of the attention object to white (color with all plates 0%).

While an object not yet selected as the attention object is contained in the received image forming information, the control section 11 repeats step S15 and the later steps (S20) and if color is set for all objects, the processing is terminated.

If the drawing replacement processing is not contained (NO) at step S12, the control section 11 goes to step 314 and continues processing.

If setting of knock out is not made (NO) at step S11, the control section 11 sets the color of each object as in the setup command for all objects, reflects the setting on the image forming information (S21), and terminates processing.

If no overprint command is set for the attention object (NO) at step S17, the control section 11 sets the color of the attention object as the command set for the attention object, reflects the result on the image forming information (S22), and goes to step S20.

Further, if the drawing color specified for the attention object is not white (color with all plates 0%) (NO) at step S16, the control section 11 goes to step S20. After completing the processing shown in FIG. 5, the control section 11 outputs the image forming information after the processing to the image forming apparatus 3.

According to the example, processing of rewriting a drawing command of an image element with setting of overprint and to be drawn in white to a drawing command of overwriting in white is described in the image forming information and in the image forming apparatus 3, a drawing command of an image element with setting of overprint and to be drawn in white is rewritten to a drawing command of overwriting in white and image forming intended by the user is performed.

In the description given so far, in the processing in FIG. 3, FIG. 5, the overprint command (over command) is deleted, whereby the command is invalidated, but it may be processed so as to be handled as a comment (comment out) without deletion and may be invalidated.

The foregoing description of the exemplary embodiment of the present invention has been provided for the purpose of illustration and description. It is not intended to be exhaustive or to limit the invention to the precise forms disclosed. Obviously, many modifications and various will be apparent to practitioners skilled in the art. The embodiments were chosen and described in order to best explain the principles of the invention and its practical application, thereby enabling other skilled in the art to understand the invention for various embodiments and with the various modifications as are suited to the particular use contemplated. It is intended that the scope of the invention be defined by the following claims and their equivalents.

### DESCRIPTION OF REFERENCE NUMERALS

1 Image information processing apparatus
2 Information processing apparatus
3 Image forming apparatus
11 Control section
12 Storage section
13 Communication section.

What is claimed is:

1. An image information processing apparatus comprising:
an input unit to which image forming information containing a drawing command for an apparatus for forming an image on a medium is input;
a search unit that searches the image forming information for a given drawing command of a white image element, the given drawing command containing an over command to set a color of a portion overlapping a different image element in a color determined by a relationship with the color of the different image element; and
an invalidation unit that invalidates the over command in the given drawing command found by the search unit.

2. An image information processing apparatus comprising:
an input unit to which image forming information containing a command of processing to be performed in an apparatus for forming an image on a medium and a drawing command are input;
a search unit that searches the command of processing contained in the image forming information for a given command of processing of replacing an over command with a command to draw nothing, the over command is to draw a color of a portion overlapping a different image element in an image element set to be drawn in white in a color determined by a relationship with the color of the different image element;
a rewrite unit that rewrites the given command of the processing found by the search unit to a certain command to draw the image element set so as to be drawn in white in the given command on a black colorplate; and
an invalidation unit that invalids the over command in the drawing command with respect to the white image element.

3. A computer readable medium storing a program causing a computer to execute process for processing image information, the process comprising:
receiving image forming information containing a drawing command for an apparatus for forming an image on a medium;
searching the image forming information for a given drawing command of a white image element, the given drawing command containing an over command to set a color of a portion overlapping a different image element in a color determined by a relationship with the color of the different image element; and
invalidating the over command in the given drawing command found by the searching process.

4. A computer readable medium storing a program causing a computer to execute process for processing image information, the process comprising:
receiving image forming information containing a command of processing to be performed in an apparatus for forming an image on a medium and a drawing command;
searching the command of processing contained in the image forming information for a given command of processing of replacing an over command with a command to draw nothing, the over command is to draw a color of a portion overlapping a different image element in an image element set to be drawn in white in a color determined by a relationship with the color of the different image element;
rewriting the given command of the processing found by the search unit to a certain command to draw the image element set so as to be drawn in white in the given command on a black colorplate; and
invalidates the over command in the drawing command with respect to the white image element.

5. An image information processing method comprising:
receiving image forming information containing a drawing command for an apparatus for forming an image on a medium;
searching the image forming information for a given drawing command of a white image element, the given drawing command containing an over command to set a color of a portion overlapping a different image element in a color determined by a relationship with the color of the different image element; and
invalidating the over command in the given drawing command found by the searching process.

6. An image information processing method comprising:
receiving image forming information containing a command of processing to be performed in an apparatus for forming an image on a medium and a drawing command;
searching the command of processing contained in the image forming information for a given command of processing of replacing an over command with a command to draw nothing, the over command is to draw a color of a portion overlapping a different image element in an image element set to be drawn in white in a color determined by a relationship with the color of the different image element;
rewriting the given command of the processing found by the search unit to a certain command to draw the image element set so as to be drawn in white in the given command on a black colorplate; and
invalidates the over command in the drawing command with respect to the white image element.

7. An image information processing apparatus comprising:
a processing unit that executes a process so as not to output information with respect to pixel of a given object when image forming information containing the given object to which a write command in white and an over command are aimed.
